(19) United States
(12) Patent Application Publication
(10) Pub. No.: US 2024/0262710 A1
(43) Pub. Date: Aug. 8, 2024

(54) METHOD FOR SYNTHESISING SPHERICAL MATERIAL PARTICLES

(71) Applicants: CENTRE NATIONAL DE LA RECHERCHE SCIENTIFIQUE, Paris (FR); UNIVERSITÉ DE BORDEAUX, Bordeaux (FR); INSTITUT POLYTECHNIQUE DE BORDEAUX, Talence (FR)

(72) Inventors: Cyril AYMONIER, Bègles (FR); Emmanuel PETIT, Martillac (FR); Guillaume AUBERT, Pessac (FR); Laurence CROGUENNEC, Pessac Cedex (FR)

(21) Appl. No.: 18/565,313

(22) PCT Filed: Jun. 2, 2022
(86) PCT No.: PCT/EP2022/065130

§ 371 Date: Nov. 29, 2023

(30) Foreign Application Priority Data
Jun. 2, 2021 (FR) FR2105819

(51) Int. Cl. C01G 53/00; B01J 19/00; H01M 4/525

(52) U.S. Cl. CPC C01G 53/50; B01J 19/0006; B01J 19/0093; B01J 2219/00033; B01J 2219/0086; B01J 2219/00984; C01P 2002/52; C01P 2002/72; C01P 2002/88; C01P 2004/03; C01P 2004/32; C01P 2006/40; H01M 4/525

(57) ABSTRACT

A method for synthesising spherical material particles carried out in a continuous reactor. An intake tube is supplied with a solution A including at least one transition metal sulfate and the other intake tube being supplied with a solution B comprising hydroxide or a carbonate. The method includes delivering solutions A and B to a reaction tube at a flow rate d_{A} and d_{B}, and recovering the precipitated precursor at the outlet of the reaction tube. The length of the reaction tube and the delivery flow rates d_{A} and d_{B} are configured such that the residence time in the reaction tube is less than or equal to 10 seconds, wherein the pH in the reaction tube is 7 to 12 and wherein the regime in the reaction tube is a laminar regime.

The invention relates to a method for synthesising spherical material particles, and in particular a method for synthesising precursors for battery electrode materials.

The synthesis of transition metal precursors (Ni, Mn, Co, etc.) with controlled morphologies and/or compositions is currently carried out using various methods such as co-precipitation, the sol-gel method or the solid-solid technique. These different synthesis techniques can be used to obtain mixtures of transition metals in the form of carbonates or hydroxides. Co-precipitation is the most commonly used method as it produces in particular aggregates that are homogeneous in morphology and composition. It is mainly carried out in thermostatically-controlled stirred reactors into which are injected a solution containing the transition metals and an alkaline solution (containing a carbonate or hydroxide⁻ for example), which will precipitate with the transition metals. Unfortunately, this technique requires maturation times of several hours before obtaining the desired transition metal precursors. As described by Pimenta et al. (Chem. Mater. 2017, 29, 9923-9936), for synthesising a carbonate rich in manganese, a maturation time of 4 h at 55° C. is required to obtain homogeneous spherical aggregates with the expected composition.

There is therefore a need to improve these conventional synthesis methods.

CN110875472 describes a synthesis device having a T-shaped microfluidic reactor supplied with two solutions: a first solution comprising a mixture of metal salts and a second alkaline solution; leading into a maturation tank. Unfortunately, here too, maturation of 2 to 10 hours in the maturation tank is required to obtain the desired transition metal precursors.

The document H. Liang et al., Chemical Engineering Journal 394 (2020) 124846 describes another device having a T-shaped microfluidic reactor. In this document, the reactor is supplied with a first solution comprising a mixture of NiSO₄·6H₂O, CoSO₄·7H₂O and MnSO₄·H₂O with a molar ratio of Ni/Co/Mn equal to 0.6:0.2:0.2, and a second sodium carbonate solution (Na₂CO₃) dissolved in N-Cetyl-N,N,N,-trimethyl ammonium bromide. The reaction is carried out at a temperature of 60° C. and the time in the reactor is only 12 seconds. The precipitated transition metal precursors are directly recovered at the outlet of the reactor. However, this synthesis method produces aggregates of a few hundred nanometres instead of the micrometric size expected for use as an electrochemically high-performance active material in a battery.

The object of the invention is in particular to overcome these drawbacks in the prior art.

More specifically, the object of the invention is to provide a method for the rapid synthesis of a precursor of active materials of a battery electrode having a homogeneous micrometric shape.

To this end, the object of the invention is a method for synthesising spherical material particles, said method being carried out in a continuous reactor, said continuous reactor being formed by a reaction tube, said reaction tube being supplied by two intake tubes, the reaction tube having a length L, one of the two intake tubes being supplied with a solution A comprising at least one transition metal sulfate chosen from among nickel (Ni), aluminium (Al), magnesium (Mg), titanium (Ti), copper (Cu), zinc (Zn), iron (Fe), manganese (Mn) and cobalt (CO),
the other intake tube being supplied with a solution B comprising a hydroxide or a carbonate and optionally a chelating agent, said method comprising the following steps:
a) delivering solutions A and B to the reaction tube of the continuous reactor at a flow rate of d_{A} and d_{B} respectively, resulting in the precipitation of the precursor in the reaction tube, and
b) recovering said precipitated precursor at the outlet of the reaction tube, wherein the length L of the reaction tube and the delivery flow rates d_{A} and d_{B} are configured such that the residence time in the reaction tube is less than or equal to 10 seconds, and wherein the pH in the reaction tube is 7 to 12.

The inventors unexpectedly discovered that a short residence time (less than or equal to 10 seconds) in the reaction tube made it possible to obtain spherical material particles of micrometric size that are homogeneous in morphology and composition. It is in fact counter-intuitive that a shorter reaction time than reaction times of the same order of magnitude used in the prior art would make it possible to obtain aggregates that are larger in size (micrometric instead of nanometric) and more homogeneous in morphology. It is equally surprising that a drastically shorter reaction time (seconds instead of hours) results in similar-sized aggregates. These different aspects make it possible to very significantly speed up the production time for precursors for micrometric battery electrode materials.

The residence time in the reaction tube is an essential factor for carrying out the synthesis method according to the invention. According to one embodiment, the residence time in the reaction tube is between 1 millisecond and 10 seconds. In particular, the residence time in the reaction tube is at least 10 milliseconds, in particular at least 50 milliseconds, preferably at least 100 milliseconds. In the invention, “at least 10 milliseconds” is understood to be a time of less than 10 seconds and at least 10 milliseconds, at least 20 milliseconds, at least 30 milliseconds, at least 40 milliseconds, at least 50 milliseconds, at least 60 milliseconds, at least 70 milliseconds, at least 80 milliseconds, at least 90 milliseconds, at least 100 milliseconds, at least 110 milliseconds, at least 120 milliseconds, at least 130 milliseconds, at least 140 milliseconds, at least 150 milliseconds, at least 160 milliseconds, at least 170 milliseconds, at least 180 milliseconds, at least 190 milliseconds, at least 200 milliseconds, at least 210 milliseconds, at least 220 milliseconds, at least 230 milliseconds, at least 240 milliseconds, at least 250 milliseconds, at least 260 milliseconds, at least 270 milliseconds, at least 280 milliseconds, at least 290 milliseconds, at least 300 milliseconds, at least 310 milliseconds, at least 320 milliseconds, at least 330 milliseconds, at least 340 milliseconds, at least 350 milliseconds, at least 360 milliseconds, at least 370 milliseconds, at least 380 milliseconds, at least 390 milliseconds, at least 400 milliseconds, at least 410 milliseconds, at least 420 milliseconds, at least 430 milliseconds, at least 440 milliseconds, at least 450 milliseconds, at least 460 milliseconds, at least 470 milliseconds, at least 480 milliseconds, at least 490 milliseconds or at least 500 milliseconds. The residence time in the reaction tube is less than 10 seconds, in particular it can be less than or equal to 5 seconds, for example less than or equal to 1 second. In the invention, “less than 10 seconds” is understood to be a time of at least 10 milliseconds and less than 10 seconds, less than or equal to 9 seconds, less than or equal to 8 seconds, less than or equal to 7 seconds, less than or equal to 6 seconds, less than or equal to 5 seconds, less than or equal to 4 seconds, less than or equal to 3 seconds, less than or equal to 2 seconds, less than or equal to 1 seconds, less than or equal to 900 milliseconds, less than or equal to 890 milliseconds, less than or equal to 880 milliseconds, less than or equal to 870 milliseconds, less than or equal to 860 milliseconds, less than or equal to 850 milliseconds, less than or equal to 840 milliseconds, less than or equal to 830 milliseconds, less than or equal to 820 milliseconds, less than or equal to 810 milliseconds, less than or equal to 800 milliseconds, less than or equal to 790 milliseconds, less than or equal to 780 milliseconds, less than or equal to 770 milliseconds, less than or equal to 760 milliseconds, less than or equal to 750 milliseconds, less than or equal to 740 milliseconds, less than or equal to 730 milliseconds, less than or equal to 720 milliseconds, less than or equal to 710 milliseconds, less than or equal to 700 milliseconds, less than or equal to 690 milliseconds, less than or equal to 680 milliseconds, less than or equal to 670 milliseconds, less than or equal to 660 milliseconds, less than or equal to 650 milliseconds, less than or equal to 640 milliseconds, less than or equal to 630 milliseconds, less than or equal to 620 milliseconds, less than or equal to 610 milliseconds, less than or equal to 600 milliseconds, less than or equal to 590 milliseconds, less than or equal to 580 milliseconds, less than or equal to 570 milliseconds, less than or equal to 560 milliseconds, less than or equal to 550 milliseconds, less than or equal to 540 milliseconds, less than or equal to 530 milliseconds, less than or equal to 520 milliseconds, less than or equal to 510 milliseconds, less than or equal to 500 milliseconds, less than or equal to 470 milliseconds, less than or equal to 480 milliseconds, less than or equal to 490 milliseconds or less than or equal to 500 milliseconds. For example, between 1 millisecond and 10 seconds is understood in the invention to be 1 millisecond, 10 milliseconds, 50 milliseconds, 100 milliseconds, 150 milliseconds, 200 milliseconds, 250 milliseconds, 300 milliseconds, 350 milliseconds, 400 milliseconds, 450 milliseconds, 500 milliseconds, 550 milliseconds, 600 milliseconds, 650 milliseconds, 700 milliseconds, 750 milliseconds, 800 milliseconds, 850 milliseconds, 900 milliseconds, 950 milliseconds, 1 second, 1.5 seconds, 2 seconds, 2.5 seconds, 3 seconds, 3.5 seconds, 4 seconds, 4.5 seconds, 5 seconds, 5.5 seconds, 6 seconds, 6.5 seconds, 7 seconds, 7.5 seconds, 8 seconds, 8.5 seconds, 9 seconds, 9.5 seconds and 10 seconds.

According to one embodiment of the invention, the regime in the reaction tube is a laminar regime. The inventors unexpectedly discovered that having only laminar flow in the reaction tube resulted, against all expectations, in greater reaction efficiency. In fact, on the contrary, it is common practice in the prior art to try to obtain turbulent regimes in order to increase the probability of the reactants meeting, in particular by using high flow rates in small diameter tubes or by adding elements such as balls or stationary mixing elements to the reaction tube. The conditions of the invention make it possible to obtain precursors having at least two transition metals, which is impossible with an intermediate or turbulent regime.

“Laminar regime” is understood in the invention to mean a fluid flow mode in which all the fluid flows more or less in the same direction, without local differences counteracting each other. A laminar regime can in particular be characterized by a Reynolds number of less than 1500.

“Intermediate regime” is understood in the invention to mean a fluid flow mode in which all the fluid flows more or less in the same direction with a little mixing (small eddies). An intermediate regime can in particular be characterized by a Reynolds number of 1500 to 3000.

“Turbulent regime” is understood in the invention to mean a fluid flow mode in which all the fluid has eddies at every point, the size, location and orientation of which vary constantly. A turbulent regime can in particular be characterized by a Reynolds number greater than 3000.

According to one embodiment of the invention, the regime in the reaction tube is laminar and has a Reynolds number of less than 1500. Preferably, the regime in the reaction tube is laminar and has a Reynolds number of less than 1000, more preferably, the regime in the reaction tube is laminar and has a Reynolds number of less than 500.

The length L of the reaction tube of the continuous reactor used in the synthesis method of the invention can assume any dimension provided that the residence time in said tube is less than or equal to 10 seconds. The length L of the tube is adapted to the flow rate of solutions A and B and in particular to obtain a laminar regime in the reaction tube. In particular, the length L of the reaction tube is at least 1 mm.

According to the invention, the inner diameter of each intake tube is adapted to obtain a laminar regime.

In particular, the inner diameter of each intake tube and of the reaction tube is at least 0.5 mm.

The reaction tube and the intake tubes are preferably simple tubes, i.e. without any internal element. The reaction tube and the intake tubes preferably have a circular section.

The inner diameter of each intake tube and of the reaction tube is preferably greater than 1 mm, in particular greater than 1 cm, for example greater than 2 cm. More preferably, the inner diameter of each intake tube and of the reaction tube is between 1 and 1.5 mm.

The synthesis method according to the invention advantageously does not require heating of the reaction tube in order to obtain the precursor. The synthesis method can advantageously be carried out at room temperature as well as at higher temperatures. On this basis, the temperature in the reaction tube is between 20° C. and 70° C., preferably between 25° C. and 50° C. “Between 20° C. and 70° C.” is understood in the invention to be 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C. and 70° C.

The range of pH values in the reaction tube is obtained by adjusting the concentrations of the compounds in solutions A and B and/or the injection flow rates of solutions A and B. The pH in the reaction tube preferably has a value of 7 to 10, in particular 8, when a carbonate is present in the solution B. When a hydroxide is present in the solution B, the pH in the reaction tube has a value of 9 to 12, in particular 11.

The synthesis method according to the invention can be used to obtain any type of precursor of active materials of battery electrodes, such as precursors for Li-ion or Na-ion batteries.

According to one embodiment of the invention, the solution A comprises at least two transition metal sulfates chosen from among nickel (Ni), aluminium (Al), magnesium (Mg), titanium (Ti), copper (Cu), zinc (Zn), iron (Fe), manganese (Mn) and cobalt (Co). In particular, the solution comprises at least three transition metal sulfates, in particular at least four, in particular at least five, particularly at least six, in particular at least seven, in particular at least eight or the transition metal sulfates.

According to one embodiment of the invention, the solution A comprises at least one transition metal sulfate, in particular at least two, in particular at least three, particularly four transition metal sulfates chosen from among nickel (Ni), aluminium (Al), manganese (Mn) and cobalt (Co), in particular whose molar ratio Ni:Co:Mn:Al is 0-1: 0-1:0-1: 0-1.

In particular, the solution A comprises one of the fourteen following combinations of transition metal sulfates:

TABLE 1

| Combination | Ni | Al | Mn | Co |
|---|---|---|---|---|
| 1 | ± | | | |
| 2 | | | | ± |
| 3 | | | ± | |
| 4 | ± | ± | | |
| 5 | ± | | ± | |
| 6 | ± | | | ± |
| 7 | | ± | ± | |
| 8 | | ± | | ± |
| 9 | | | ± | ± |
| 10 | ± | ± | ± | |
| 11 | ± | ± | | ± |
| 12 | ± | | ± | ± |
| 13 | | ± | ± | ± |
| 14 | ± | ± | ± | ± |

For example, the molar ratio Ni:Ca:Mn:Al is 0.8:0.05:0.1:0.05 or 0.2:0.15:0.6:0.05. In particular, the precursor comprises the transition metals Ni, Mn and Co with a molar ratio Ni:Mn:Co of ⅓:⅓:⅓, or 0.2:0.5:0.3. In particular, the precursor comprises the transition metals Ni and Mn with a molar ratio Ni:Mn of 0.25:0.75. Such a composition of transition metals is used in particular to obtain precursors for Li-ion batteries. In particular, the solution A also comprises at least one transition metal sulfate, in particular at least two, in particular at least three, in particular at least four, particularly five transition metal sulfates chosen from among magnesium (Mg), titanium (Ti), copper (Cu), zinc (Zn) and iron (Fe). Such a composition of the solution A is used in particular to obtain precursors for Na-ion batteries.

In particular, the solution A comprises one of the 433 following combinations of transition metal sulfates:

TABLE 2

| Combination | Ni | Al | Mn | Co | Mg | Ti | Cu | Zn | Fe |
|---|---|---|---|---|---|---|---|---|---|
| 1 | + | | | | + | | | | |
| 2 | + | | | | | + | | | |
| 3 | + | | | | | | + | | |
| 4 | + | | | | | | | + | |
| 5 | + | | | | | | | | + |
| 6 | + | | | | + | + | | | |
| 7 | + | | | | + | | + | | |
| 8 | + | | | | + | | | + | |
| 9 | + | | | | + | | | | + |
| 10 | + | | | | | + | + | | |
| 11 | + | | | | | + | | + | |
| 12 | + | | | | | + | | | + |
| 13 | + | | | | | | + | + | |
| 14 | + | | | | | | + | | + |
| 15 | + | | | | | | | + | + |
| 16 | + | | | | + | + | + | | |
| 17 | + | | | | + | + | | + | |
| 18 | + | | | | + | | + | + | |
| 19 | + | | | | + | | | + | + |
| 20 | + | | | | | + | + | + | |
| 21 | + | | | | | + | + | + | |
| 22 | + | | | | | + | | + | + |
| 23 | + | | | | | | + | + | + |
| 24 | + | | | | + | + | + | + | |
| 25 | + | | | | + | + | + | | + |
| 26 | + | | | | + | + | | + | + |
| 27 | + | | | | + | | + | + | + |
| 28 | + | | | | | + | + | + | + |
| 29 | + | | | | + | + | + | + | + |
| 30 | | + | | | | + | | | |
| 31 | | + | | | | | + | | |
| 32 | | + | | | | | | | + |
| 33 | | + | | | + | + | | | |
| 34 | | + | | | + | | + | | |
| 35 | | + | | | + | | | + | |
| 36 | | + | | | + | | | | + |
| 37 | | + | | | | + | + | | |
| 38 | | + | | | | + | | + | |
| 39 | | + | | | | + | | | + |
| 40 | | + | | | | | + | + | |
| 41 | | + | | | | | + | | + |
| 42 | | + | | | | | | + | + |
| 43 | | + | | | + | + | + | | |
| 44 | | + | | | + | + | | + | |
| 45 | | + | | | + | | + | + | |
| 46 | | + | | | + | | | + | + |
| 47 | | + | | | | + | + | + | |
| 48 | | + | | | | + | + | + | |
| 49 | | + | | | | + | | + | + |
| 50 | | + | | | | | + | + | + |
| 51 | | + | | | + | + | + | + | |
| 52 | | + | | | + | + | + | | + |
| 53 | | + | | | + | + | | + | + |
| 54 | | + | | | + | | + | + | + |
| 55 | | + | | | | + | + | + | + |
| 56 | | + | | | | | | | |
| 57 | | | + | | + | | | | |
| 58 | | | + | | | + | | | |
| 59 | | | + | | | | + | | |
| 60 | | | + | | | | | + | |
| 61 | | | + | | | | | | + |
| 62 | | | + | + | + | | | | |
| 63 | | | + | | + | | + | | |
| 64 | | | + | | + | | | + | |
| 65 | | | + | | + | | | | + |
| 66 | | | + | | | + | + | | |
| 67 | | | + | | | + | | + | |
| 68 | | | + | | | + | | | + |
| 69 | | | + | | | | + | + | |
| 70 | | | + | | | | + | | + |
| 71 | | | + | | | | | + | + |
| 72 | | | + | | + | + | + | | |
| 73 | | | + | | + | + | | + | |
| 74 | | | + | | + | | + | + | |
| 75 | | | + | | + | | | + | + |
| 76 | | | + | | | + | + | + | |
| 77 | | | + | | | + | + | + | |
| 78 | | | + | | | + | | + | + |
| 79 | | | + | | | | + | + | + |
| 80 | | | + | | + | + | + | + | |
| 81 | | | + | | + | + | + | | + |
| 82 | | | + | | + | + | | + | + |
| 83 | | | + | | + | | + | + | + |
| 84 | | | + | | | + | + | + | + |
| 85 | | | + | | | | | | |
| 86 | | | | + | + | | | | |
| 87 | | | | + | | + | | | |
| 88 | | | | + | | | + | | |
| 89 | | | | + | | | | + | |
| 90 | | | | + | | | | | + |
| 91 | | | | + | + | + | | | |
| 92 | | | | + | + | | + | | |
| 93 | | | | + | + | | | + | |
| 94 | | | | + | + | | | | + |
| 95 | | | | + | | + | + | | |
| 96 | | | | + | | + | | + | |
| 97 | | | | + | | + | | | + |
| 98 | | | | + | | | + | + | |
| 99 | | | | + | | | + | | + |
| 100 | | | | + | | | | + | + |
| 101 | | | | + | + | + | + | | |
| 102 | | | | + | + | + | | + | |
| 103 | | | | + | + | | + | + | |
| 104 | | | | + | + | | | + | + |
| 105 | | | | + | | + | + | + | |
| 106 | | | | + | | + | + | + | |
| 107 | | | | + | | + | | + | + |
| 108 | | | | + | | | + | + | + |
| 109 | | | | + | + | + | + | + | |
| 110 | | | | + | + | + | + | | + |
| 111 | | | | + | + | + | | + | + |
| 112 | | | | + | + | | + | + | + |
| 113 | | | | + | | + | + | + | + |
| 114 | | | | + | + | + | + | + | + |
| 115 | + | + | | | + | | | | |
| 116 | + | + | | | | + | | | |
| 117 | + | + | | | | | + | | |
| 118 | + | + | | | | | | + | |
| 119 | + | + | | | | | | | + |
| 120 | + | + | | | + | + | | | |
| 121 | + | + | | | + | | + | | |
| 122 | + | + | | | + | | | + | |
| 123 | + | + | | | + | | | | + |
| 124 | + | + | | | | + | + | | |
| 125 | + | + | | | | + | | + | |
| 126 | + | + | | | | + | | | + |
| 127 | + | + | | | | | + | + | |
| 128 | + | + | | | | | + | | + |
| 129 | + | + | | | | | | + | + |
| 130 | + | + | | | + | + | + | | |
| 131 | + | + | | | + | + | | + | |
| 132 | + | + | | | + | | + | + | |
| 133 | + | + | | | + | | | + | + |
| 134 | + | + | | | | + | + | + | |
| 135 | + | + | | | | + | + | + | |
| 136 | + | + | | | | + | | + | + |
| 137 | + | + | | | | | + | + | + |
| 138 | + | + | | | + | + | + | + | |
| 139 | + | + | | | + | + | + | | + |
| 140 | + | + | | | + | + | | + | + |
| 141 | + | + | | | + | | + | + | + |
| 142 | + | + | | | | + | + | + | + |
| 143 | + | + | | | + | + | + | + | + |
| 144 | + | | + | | + | | | | |
| 145 | + | | + | | | + | | | |
| 146 | + | | + | | | | + | | |
| 147 | + | | + | | | | | + | |
| 148 | + | | + | | | | | | + |
| 149 | + | | + | | + | + | | | |
| 150 | + | | + | | + | | + | | |
| 151 | + | | + | | + | | | + | |
| 152 | + | | + | | + | | | | + |
| 153 | + | | + | | | + | + | | |
| 154 | + | | + | | | + | | + | |
| 155 | + | | + | | | + | | | + |
| 156 | + | | + | | | | + | + | |
| 157 | + | | + | | | | + | | + |
| 158 | + | | + | | | | | + | + |
| 159 | + | | + | | + | + | + | | |
| 160 | + | | + | | + | + | | + | |
| 161 | + | | + | | + | | + | + | |
| 162 | + | | + | | + | | | + | + |
| 163 | + | | + | | | + | + | + | |
| 164 | + | | + | | | + | + | + | |
| 165 | + | | + | | | + | | + | + |
| 166 | + | | + | | | | + | + | + |
| 167 | + | | + | | + | + | + | + | |
| 168 | + | | + | | + | + | + | | + |
| 169 | + | | + | | + | + | | + | + |
| 170 | + | | + | | + | | + | + | + |
| 171 | + | | + | | | + | + | + | + |
| 172 | + | | + | | + | + | + | + | + |
| 173 | + | | | + | + | | | | |
| 174 | + | | | + | | + | | | |
| 175 | + | | | + | | | + | | |
| 176 | + | | | + | | | | + | |
| 177 | + | | | + | | | | | + |
| 178 | + | | | + | + | + | | | |
| 179 | + | | | + | + | | + | | |
| 180 | + | | | + | + | | | + | |
| 181 | + | | | + | + | | | | + |
| 182 | + | | | + | | + | + | | |
| 183 | + | | | + | | + | | + | |
| 184 | + | | | + | | + | | | + |
| 185 | + | | | + | | | + | + | |
| 186 | + | | | + | | | + | | + |
| 187 | + | | | + | | | | + | + |
| 188 | + | | | + | + | + | + | | |
| 189 | + | | | + | + | + | | + | |
| 190 | + | | | + | + | | + | + | |
| 191 | + | | | + | + | | | + | + |
| 192 | + | | | + | | + | + | + | |
| 193 | + | | | + | | + | + | + | |
| 194 | + | | | + | | + | | + | + |
| 195 | + | | | + | | | + | + | + |
| 196 | + | | | + | + | + | + | + | |
| 197 | + | | | + | + | + | + | | + |
| 198 | + | | | + | + | + | | + | + |
| 199 | + | | | + | + | | + | + | + |
| 200 | + | | | + | | + | + | + | + |
| 201 | + | | | + | + | + | + | + | + |
| 202 | | + | + | | + | | | | |
| 203 | | + | + | | | + | | | |
| 204 | | + | + | | | | + | | |
| 205 | | + | + | | | | | + | |
| 206 | | + | + | | | | | | + |
| 207 | | + | + | | + | + | | | |
| 208 | | + | + | | + | | + | | |
| 209 | | + | + | | + | | | + | |
| 210 | | + | + | | + | | | | + |
| 211 | | + | + | | | + | + | | |
| 212 | | + | + | | | + | | + | |
| 213 | | + | + | | | + | | | + |
| 214 | | + | + | | | | + | + | |
| 215 | | + | + | | | | + | | + |
| 216 | | + | + | | | | | + | + |
| 217 | | + | + | | + | + | + | | |
| 218 | | + | + | | + | + | | + | |
| 219 | | + | + | | + | | + | + | |
| 220 | | + | + | | + | | | + | + |
| 221 | | + | + | | | + | + | + | |
| 222 | | + | + | | | + | + | + | |
| 223 | | + | + | | | + | | + | + |
| 224 | | + | + | | | | + | + | + |
| 225 | | + | + | | + | + | + | + | |
| 226 | | + | + | | + | + | + | | + |
| 227 | | + | + | | + | + | | + | + |
| 228 | | + | + | | + | | + | + | + |
| 229 | | + | + | | | + | + | + | + |
| 230 | | + | + | | + | + | + | + | + |
| 231 | | + | | + | + | | | | |
| 232 | | + | | + | | + | | | |
| 233 | | + | | + | | | + | | |
| 234 | | + | | + | | | | + | |
| 235 | | + | | + | | | | | + |
| 236 | | + | | + | + | + | | | |
| 237 | | + | | + | + | | + | | |
| 238 | | + | | + | + | | | + | |
| 239 | | + | | + | + | | | | + |
| 240 | | + | | + | | + | + | | |
| 241 | | + | | + | | + | | + | |
| 242 | | + | | + | | + | | | + |
| 243 | | + | | + | | | + | + | |
| 244 | | + | | + | | | + | | + |
| 245 | | + | | + | | | | + | + |
| 246 | | + | | + | + | + | + | | |
| 247 | | + | | + | + | + | | + | |
| 248 | | + | | + | + | | + | + | |
| 249 | | + | | + | + | | | + | + |
| 250 | | + | | + | | + | + | + | |
| 251 | | + | | + | | + | + | + | |
| 252 | | + | | + | | + | | + | + |
| 253 | | + | | + | | | + | + | + |
| 254 | | + | | + | + | + | + | + | |
| 255 | | + | | + | + | + | + | | + |
| 256 | | + | | + | + | + | | + | + |
| 257 | | + | | + | + | | + | + | + |
| 258 | | + | | + | | + | + | + | + |
| 259 | | + | | + | + | + | + | + | + |
| 260 | | | + | + | + | | | | |
| 261 | | | + | + | | + | | | |
| 262 | | | + | + | | | + | | |
| 263 | | | + | + | | | | + | |
| 264 | | | + | + | | | | | + |
| 265 | | | + | + | + | + | | | |
| 266 | | | + | + | + | | + | | |
| 267 | | | + | + | + | | | + | |
| 268 | | | + | + | + | | | | + |
| 269 | | | + | + | | + | + | | |
| 270 | | | + | + | | + | | + | |
| 271 | | | + | + | | + | | | + |
| 272 | | | + | + | | | + | + | |
| 273 | | | + | + | | | + | | + |
| 274 | | | + | + | | | | + | + |
| 275 | | | + | + | + | + | + | | |
| 276 | | | + | + | + | + | | + | |
| 277 | | | + | + | + | | + | + | |
| 278 | | | + | + | + | | | + | + |
| 279 | | | + | + | | + | + | + | |
| 280 | | | + | + | | + | + | + | |
| 281 | | | + | + | | + | | + | + |
| 282 | | | + | + | | | + | + | + |
| 283 | | | + | + | + | + | + | + | |
| 284 | | | + | + | + | + | + | | + |
| 285 | | | + | + | + | + | | + | + |
| 286 | | | + | + | + | | + | + | + |
| 287 | | | + | + | | + | + | + | + |
| 288 | | | + | + | + | + | + | + | + |
| 289 | + | + | + | | + | | | | |
| 290 | + | + | + | | | + | | | |
| 291 | + | + | + | | | | + | | |
| 292 | + | + | + | | | | | + | |
| 293 | + | + | + | | | | | | + |
| 294 | + | + | + | | + | + | | | |
| 295 | + | + | + | | + | | + | | |
| 296 | + | + | + | | + | | | + | |
| 297 | + | + | + | | + | | | | + |
| 298 | + | + | + | | | + | + | | |
| 299 | + | + | + | | | + | | + | |
| 300 | + | + | + | | | + | | | + |
| 301 | + | + | + | | | | + | + | |
| 302 | + | + | + | | | | + | | + |
| 303 | + | + | + | | | | | + | + |
| 304 | + | + | + | | + | + | + | | |
| 305 | + | + | + | | + | + | | + | |
| 306 | + | + | + | | + | | + | + | |
| 307 | + | + | + | | + | | | + | + |
| 308 | + | + | + | | | + | + | + | |
| 309 | + | + | + | | | + | + | + | |
| 310 | + | + | + | | | + | | + | + |
| 311 | + | + | + | | | | + | + | + |
| 312 | + | + | + | | + | + | + | + | |
| 313 | + | + | + | | + | + | + | | + |
| 314 | + | + | + | | + | + | | + | + |
| 315 | + | + | + | | + | | + | + | + |
| 316 | + | + | + | | | + | + | + | + |
| 317 | + | + | + | | + | + | + | + | + |
| 318 | + | + | | + | + | | | | |
| 319 | + | + | | + | | + | | | |
| 320 | + | + | | + | | | + | | |
| 321 | + | + | | + | | | | + | |
| 322 | + | + | | + | | | | | + |
| 323 | + | + | | + | + | + | | | |
| 324 | + | + | | + | + | | + | | |
| 325 | + | + | | + | + | | | + | |
| 326 | + | + | | + | + | | | | + |
| 327 | + | + | | + | | + | + | | |
| 328 | + | + | | + | | + | | + | |
| 329 | + | + | | + | | + | | | + |
| 330 | + | + | | + | | | + | + | |
| 331 | + | + | | + | | | + | | + |
| 332 | + | + | | + | | | | + | + |
| 333 | + | + | | + | + | + | + | | |
| 334 | + | + | | + | + | + | | + | |
| 335 | + | + | | + | + | | + | + | |
| 336 | + | + | | + | + | | | + | + |
| 337 | + | + | | + | | + | + | + | |
| 338 | + | + | | + | | + | + | + | |
| 339 | + | + | | + | | + | | + | + |
| 340 | + | + | | + | | | + | + | + |
| 341 | + | + | | + | + | + | + | + | |
| 342 | + | + | | + | + | + | + | | + |
| 343 | + | + | | + | + | + | | + | + |
| 344 | + | + | | + | + | | + | + | + |
| 345 | + | + | | + | | + | + | + | + |
| 346 | + | + | | + | + | + | + | + | + |
| 347 | + | | + | + | + | | | | |
| 348 | + | | + | + | | + | | | |
| 349 | + | | + | + | | | + | | |
| 350 | + | | + | + | | | | + | |
| 351 | + | | + | + | | | | | + |
| 352 | + | | + | + | + | + | | | |
| 353 | + | | + | + | + | | + | | |
| 354 | + | | + | + | + | | | + | |
| 355 | + | | + | + | + | | | | + |
| 356 | + | | + | + | | + | + | | |
| 357 | + | | + | + | | + | | + | |
| 358 | + | | + | + | | + | | | + |
| 359 | + | | + | + | | | + | + | |
| 360 | + | | + | + | | | + | | + |
| 361 | + | | + | + | | | | + | + |
| 362 | + | | + | + | + | + | + | | |
| 363 | + | | + | + | + | + | | + | |
| 364 | + | | + | + | + | | + | + | |
| 365 | + | | + | + | + | | | + | + |
| 366 | + | | + | + | | + | + | + | |
| 367 | + | | + | + | | + | + | + | |
| 368 | + | | + | + | | + | | + | + |
| 369 | + | | + | + | | | + | + | + |
| 370 | + | | + | + | + | + | + | + | |
| 371 | + | | + | + | + | + | + | | + |
| 372 | + | | + | + | + | + | | + | + |
| 373 | + | | + | + | + | | + | + | + |
| 374 | + | | + | + | | + | + | + | + |
| 375 | + | | + | + | + | + | + | + | + |
| 376 | | + | + | + | + | | | | |
| 377 | | + | + | + | | + | | | |
| 378 | | + | + | + | | | + | | |
| 379 | | + | + | + | | | | + | |
| 380 | | + | + | + | | | | | + |
| 381 | | + | + | + | + | + | | | |
| 382 | | + | + | + | + | | + | | |
| 383 | | + | + | + | + | | | + | |
| 384 | | + | + | + | + | | | | + |
| 385 | | + | + | + | | + | + | | |
| 386 | | + | + | + | | + | | + | |
| 387 | | + | + | + | | + | | | + |
| 388 | | + | + | + | | | + | + | |
| 389 | | + | + | + | | | + | | + |
| 390 | | + | + | + | | | | + | + |
| 391 | | + | + | + | + | + | + | | |
| 392 | | + | + | + | + | + | | + | |
| 393 | | + | + | + | + | | + | + | |
| 394 | | + | + | + | + | | | + | + |
| 395 | | + | + | + | | + | + | + | |
| 396 | | + | + | + | | + | + | + | |
| 397 | | + | + | + | | + | | + | + |
| 398 | | + | + | + | | | + | + | + |
| 399 | | + | + | + | + | + | + | + | |
| 400 | | + | + | + | + | + | + | | + |
| 401 | | + | + | + | + | + | | + | + |
| 402 | | + | + | + | + | | + | + | + |
| 403 | | + | + | + | | + | + | + | + |
| 404 | | + | + | + | + | + | + | + | + |
| 405 | + | + | + | + | + | | | | |
| 406 | + | + | + | + | | + | | | |
| 407 | + | + | + | + | | | + | | |
| 408 | + | + | + | + | | | | + | |
| 409 | + | + | + | + | | | | | + |
| 410 | + | + | + | + | + | + | | | |
| 411 | + | + | + | + | + | | + | | |
| 412 | + | + | + | + | + | | | + | |
| 413 | + | + | + | + | + | | | | + |
| 414 | + | + | + | + | | + | + | | |
| 415 | + | + | + | + | | + | | + | |
| 416 | + | + | + | + | | + | | | + |
| 417 | + | + | + | + | | | + | + | |
| 418 | + | + | + | + | | | + | | + |
| 419 | + | + | + | + | | | | + | + |
| 420 | + | + | + | + | + | + | + | | |
| 421 | + | + | + | + | + | + | | + | |
| 422 | + | + | + | + | + | | + | + | |
| 423 | + | + | + | + | + | | | + | + |
| 424 | + | + | + | + | | + | + | + | |
| 425 | + | + | + | + | | + | + | + | |
| 426 | + | + | + | + | | + | | + | + |
| 427 | + | + | + | + | | | + | + | + |
| 428 | + | + | + | + | + | + | + | + | |
| 429 | + | + | + | + | + | + | + | | + |
| 430 | + | + | + | + | + | + | | + | + |
| 431 | + | + | + | + | + | | + | + | + |
| 432 | + | + | + | + | | + | + | + | + |
| 433 | + | + | + | + | + | + | + | + | + |

Such a composition has, for example, a nickel sulfate, a zinc sulfate, a manganese sulfate and a titanium sulfate with a molar ratio Ni:Zn:Mn:Ti equal to 0.48:0.02:0.4:0.1.

The concentration of said at least one transition metal sulfate in the solution A is 0.1 mol/l up to saturation, in particular 2 mol/l. In particular, the concentration of said at least one transition metal sulfate in the solution A is at least 0.1 mol/l. “At least 0.1 mol/l” is understood in the invention to mean at least 0.1 mol/l, at least 0.2 mol/l, at least 0.3 mol/l, at least 0.4 mol/l, at least 0.5 mol/l, at least 0.6 mol/l, at least 0.7 mol/l, at least 0.8 mol/l, at least 0.9 mol/l, at least 1 mol/l, at least 1.1 mol/l, at least 1.2 mol/l, at least 1.3 mol/l, at least 1.4 mol/l, at least 1.5 mol/l, at least 1.6 mol/l, at least 1.7 mol/l, at least 1.8 mol/l and at least 1.9 mol/l.

The solution B is an aqueous solution containing a hydroxide or a carbonate, and optionally a chelating agent.

“Hydroxide” is understood in the invention to mean any compound which, when dissolved in water, produces a hydroxide ion (OH—). This hydroxide ion precipitates with the transition metal(s) of the solution A when they come into contact in the reaction tube. According to one embodiment of the invention, the hydroxide is chosen from the group made up of sodium hydroxide, potassium hydroxide, 8-Hydroxyquinoline, ammonia, lithium hydroxide and mixtures thereof. The hydroxide is preferably sodium hydroxide. The hydroxide concentration can range from 0.1 mol/l to saturation. For example, in the case of sodium hydroxide, the saturation concentration is 27 mol/l. The hydroxide concentration is preferably 4 mol/l.

“Carbonate” is understood in the invention to mean any compound which, when dissolved in water, produces a carbonate ion (CO₃²⁻). This carbonate ion precipitates with the transition metal(s) of the solution A when they come into contact in the reaction tube. According to one embodiment, the carbonate is chosen from the group made up of ammonium bicarbonate, sodium carbonate, potassium carbonate, lithium carbonate and mixtures thereof. In particular, the carbonate is chosen from the group made up of sodium carbonate, potassium carbonate, lithium carbonate and mixtures thereof. The carbonate is preferably sodium carbonate. The carbonate concentration can range from 0.1 mol/l to saturation. In the case of sodium carbonate, the saturation corresponds to a concentration of 2 mol/l at room temperature. The carbonate concentration is preferably the saturation concentration.

“Chelating agent” is understood in the invention to mean any compound with the property of chelating/complexing the transition metal(s) present in the solution A. The presence of such a compound is advantageous in that it enables the composition to be controlled during precipitation. According to one embodiment of the invention, the chelating agent can be any type of ammonium such as primary ammoniums, secondary ammoniums, ternary ammoniums or quaternary ammoniums. In particular, the chelating agent is chosen from the group made up of ammonia and N-Cetyl-N,N,N,-trimethyl ammonium bromide. The chelating agent is preferably ammonia. The chelating agent concentration can range from 0.1 mol/l to 5 mol/l. In particular, in the case of ammonia, the concentration is preferably 0.4 mol/l.

The solutions A and B are delivered by any means, and in particular by means of any type of pump. For example, the solutions A and B are delivered by means of pumps ensuring a constant flow rate. On this basis, the pumps used can be pneumatic diaphragm pumps, peristaltic pumps or positive displacement pumps. According to one embodiment of the invention, each solution A and B is delivered by means of a peristaltic pump.

The flow rate of each solution A and B is adapted such that the residence time in the reaction tube is less than or equal to 10 seconds and in particular the regime in the reaction tube is a laminar regime. The solutions A and B can be delivered with identical or different flow rates. In particular, the flow rate of the solution A d_{A} is greater than the flow rate of the solution B d_{B}. The ratio of the flow rates of the solutions A and B d_{A}:d_{B} is preferably between 0.5:1 and 5:1. According to one embodiment of the invention, the delivery flow rates d_{A} and d_{B} are each at least 0.01 ml/min.

The intake tubes have their outlet opening in the initial part of the reaction tube. The initial part of the reaction tube is understood to be in the direction of the flow through the reaction tube. This initial part, also called mixer, is a mixing space for solutions A and B. According to one embodiment of the invention, the outlets of the intake tubes are configured such that the mixing of solutions A and B at the mixer is carried out by co-flow or counter-flow.

To obtain counter-flow mixing, the flows of the solutions A and B must be substantially parallel to each other but in opposite directions. In this way, the flow of the solution A is projected against the flow of the solution B. Counter-flow mixing can in particular be achieved by orienting the outlets of the intake tubes substantially parallel to each other and facing each other. The term “substantially” is understood here to cover a deviation of no more than 10 degrees with a parallel orientation of the two outlets of the intake tubes. The outlets can be arranged in a variety of ways. For example, the intersection between the intake tubes and the reaction tube will have a “T” shape. The remaining part of the reaction tube and intake tubes can assume any direction. Alternatively, the outlet of one of the intake tubes has a greater diameter than that of the other outlet. The mixer of the reaction tube can then correspond to the continuity of the intake tube with the largest diameter opening and include within it the end of the smallest intake tube. Here too, the remaining part of the reaction tube and intake tubes can assume any direction. In any case, the flow rate of the solutions is adapted and sufficiently high so that there is no backflow in the intake tubes. One or more non-return valves can in particular be arranged at the end of the smallest intake tube to prevent this backflow.

To achieve co-flow mixing, the solutions A and B have flows that are substantially parallel to one another and in the same direction, and the flow of one of the solutions has to be contained within the flow of the other. In this way, the two solutions are mixed in a virtual tube corresponding to the contact zone between the two solution flows. The term “substantially” is understood here to cover a deviation of no more than 10 degrees with a parallel orientation of the two outlets of the intake tubes. Co-flow can in particular be achieved by arranging the outlet of one of the intake tubes inside the outlet of the other tube. In this way, one outlet has a greater diameter than that of the other outlet. Here too, the mixer of the reaction tube corresponds to the extension of the intake tube having an outlet with the largest diameter. Here again, the remaining part of the reaction tube and intake tubes can assume any direction.

According to one embodiment of the invention, during step b) the precipitated precursor is only recovered at the outlet of the reactor after a duration of at least 5 seconds, in particular at least 10 seconds, in particular at least 20 seconds, for example at least 30 seconds. Indeed, the precipitate obtained during the first 5 seconds can exhibit a certain inhomogeneity that is no longer present after this time. The precipitate leaving the reactor in the first 5 seconds is therefore preferably not recovered.

The invention also relates to the use of a continuous reactor for synthesising spherical material particles, said continuous reactor being formed by a reaction tube, said reaction tube being supplied by two intake tubes, the reaction tube having a length L,
one of the two intake tubes being supplied with a solution A comprising at least one transition metal sulfate chosen from among nickel (Ni), aluminium (Al), magnesium (Mg), titanium (Ti), copper (Cu), zinc (Zn), iron (Fe), manganese (Mn) and cobalt (Co),
the other intake tube being supplied with a solution B comprising a hydroxide or a carbonate and optionally a chelating agent,
wherein solutions A and B are delivered to the reaction tube of the continuous reactor at a flow rate of d_{A} and d_{B} respectively, resulting in the precipitation of the precursor in the reaction tube, and said precipitated precursor is recovered at the outlet of the reaction tube,
and wherein the length L of the reaction tube and the delivery flow rates d_{A} and d_{B} are configured such that the residence time in the reaction tube is less than or equal to 10 seconds, and wherein the pH in the reaction tube is 7 to 12.

Finally, the invention relates to spherical particles obtained, or that can be obtained, using the method described above.

### BRIEF DESCRIPTION OF THE FIGURES

FIG. 1 is a diagram of a T-shaped continuous reactor used in the synthesis method according to the invention.

FIG. 2 combines two charts (A and B) relating to the chemical classification and purity of a precursor precipitated using the synthesis method according to the invention. Figure a) shows the result of an X-ray diffractogram performed on said precursor. The x-axis represents 26 in degrees and the y-axis is the intensity in arbitrary units. Figure b) shows the result of a thermogravimetric analysis carried out on 30 mg of sample of said precursor. The x-axis shows the temperature in ° C. and the y-axis shows the mass of the sample as a percentage. The double arrow indicates the loss of mass obtained at 640° C. (−35.5%).

FIG. 3 is a series of images (A and B) obtained by scanning electron microscopy of aggregates of a precursor precipitated according to the synthesis method according to the invention. The white bar shows the scale for each image.

FIG. 4 shows the distribution of the size of the aggregates of a sample of a precursor precipitated using the synthesis method according to the invention in volume (FIG. 4A) and in number (FIG. 4B). In FIG. 4A, the x-axis shows the size of the aggregates in micrometres and the y-axis shows the volume occupied by the aggregates as a percentage. In FIG. 4B, the x-axis shows the size of the aggregates in micrometres and the y-axis shows the number of aggregates as a percentage.

FIG. 5 shows the thermal cycle used to synthesise a positive electrode active material from a precursor obtained using the synthesis method according to the invention. In this figure, A represents the starting conditions corresponding to room temperature (25° C.). The temperature is then increased at a rate of 3.5° C./min until it reaches 400° C. B corresponds to decarbonization, where the temperature is maintained at 400° C. for 2 hours. The temperature is then increased at a rate of 3.5° C./min until it reaches 900° C. C corresponds to crystallization, where the temperature is maintained at 900° C. for 12 hours. The temperature is then decreased at a rate of 2° C. per minute, returning to room temperature at D.

FIG. 6 shows an X-ray diffractogram performed on a positive electrode active material obtained from a precursor obtained using the synthesis method according to the invention. The x-axis represents 26 in degrees and the y-axis is the intensity in arbitrary units. The inset shows an improved view of the diffractogram for the values 30° to 80° of 2θ. The hollow circles represent the observed intensity values. The black lines in the hollow circles represent the expected theoretical values. The black line at the bottom represents the difference between the observed values and the expected vales (an absence of peak corresponds to no observed difference). The vertical black lines above the black line represent the position of the Bragg reflections.

FIG. 7 is a series of images (A and B) obtained by scanning electron microscopy of aggregates of a positive electrode active material obtained from a precursor precipitated using the synthesis method according to the invention. The white bar shows the scale on each image.

FIG. 8 shows the evolution in discharged capacity (mAh.g⁻¹) as a function of the number of cycles of a 2032 button cell comprising a positive electrode active material obtained from a precursor precipitated using the synthesis method according to the invention.

FIG. 9 shows an X-ray diffractogram performed on two precursors obtained by comparative synthesis methods where the delivery flow rates of the solutions A and B were 4 ml/min and where the length of the reaction tube of the microfluidic reactor was 1 metre (curve 1) or 2 metres (curve 2). The x-axis represents 20 in degrees and the y-axis is the intensity in arbitrary units. The origin of the y-axis of curve 2 has been moved to make the figure easier to read.

FIG. 10 shows two images obtained by scanning electron microscopy of aggregates of precursors precipitated using a comparative synthesis method where the delivery flow rates of the solutions A and B were 4 ml/min and where the length of the reaction tube of the microfluidic reactor was 1 metre (FIG. 10A) or 2 metres (FIG. 10B). The white bar shows the scale on each image.

FIG. 11 shows the result of an X-ray diffractogram performed on a precursor Ni_{0.25}Mn_{0.75}CO₃ obtained according to the method of the invention. The x-axis represents 20 in degrees and the y-axis is the intensity in arbitrary units.

FIG. 12 is a series of images (A and B) obtained by scanning electron microscopy of aggregates of a precursor Ni_{0.25}Mn_{0.75}CO₃ obtained according to the method of the invention. The white bar shows the scale for each image.

FIG. 13 shows the result of an X-ray diffractogram performed on a precursor Ni_{1/3}Mn_{1/3}Co_{1/3}CO₃ obtained according to the method of the invention. The x-axis represents 20 in degrees and the y-axis is the intensity in arbitrary units.

FIG. 14 is a series of images (A and B) obtained by scanning electron microscopy of aggregates of a precursor Ni_{1/3}Mn_{1/3}Co_{1/3}CO₃ obtained according to the method of the invention. The white bar shows the scale for each image.

FIG. 15 shows the result of an X-ray diffractogram performed on a precursor Ni_{1/3}Mn_{1/3}Co_{1/3}CO₃ obtained according to a method in which the regime in the reaction tube is turbulent. The x-axis represents 20 in degrees and the y-axis is the intensity in arbitrary units.

FIG. 16 is a series of images (A, B and C) obtained by scanning electron microscopy of aggregates of a precursor Ni_{1/3}Mn_{1/3}Co_{1/3}CO₃ obtained according to a method in which the regime in the reaction tube is turbulent. The white bar shows the scale for each image.

### EXAMPLES

### 1. T-Shaped Continuous Reactor

The continuous reactor 1 used in the invention is shown in FIG. 1. This figure shows the T-shaped continuous reactor made up of two intake tubes 3 facing each other, each supplied with a solution (A or B) joining at an intersection leading into a reaction tube 5 perpendicular to the direction of the intake tubes 3 at the intersection. A counter-flow is thus achieved at the intersection of the two intake tubes 3. The solution A contains the transition metal sulfates and the solution B comprises a hydroxide or a carbonate as well as a complexing agent. The solutions A and B are delivered to the reactor 1 thanks to peristaltic pumps 7. The precursor precipitates in the reaction tube, which leads into a tank 9 where the precipitated precursor is recovered.

### 2. Carbonate Precursor Ni_{0.2}Mn_{0.5}Co_{0.3}CO₃

The inventors first of all synthesized a carbonate precursor rich in manganese, the composition of which is Ni_{0.2}Mn_{0.5}Co_{0.3}CO₃.

### a. Preparing Starting Solutions

To do so, a solution A of 250 mL of transition metal sulfates was prepared by weighing 26.29 g of NiSO₄·6H₂O, 42.26 g of MnSO₄·H₂O and 42.17 g of CoSO₄·7H₂O. These sulfates were dissolved in distilled water then placed in a volumetric flask of 250 mL filled to the mark. The Ni/Mn/Co molar ratio is 2/5/3. The concentration of this solution is 2 mol/l. A solution B of 250 mL containing sodium carbonate and a complexing agent (NH₄OH) was prepared by dissolving 47.69 g of Na₂CO₃ and 11.26 g of NH₄OH in distilled water then placed in a volumetric flask of 250 mL filled to the mark. The concentration of Na₂CO₃ is 1.8 mol/L and the concentration of NH₄OH is 0.36 mol/L.

### b. Synthesis Conditions

The sampling flow rate for the solution containing the transition metals was 20 mL/min while the sampling flow rate for the solution containing the carbonate was 12 mL/min. The pH of the solution containing the precipitate was 7.8. The discharge tube from the reactor was 10 cm long and had an inner diameter of 1.39 mm. Under these conditions, the residence time in the discharge tube from the reactor was 0.3 s and the regime of the fluid in the reactor was laminar. The precipitate was not sampled for the first 30 seconds of the reaction, then sampled for 60 seconds. It is then washed by centrifugation with distilled water (until the wash water has been neutralized) and dried in an oven at 70° C. for 1 night.

The mass of transition metal carbonate recovered after drying was 2.56 g, in line with the expected theoretical quantity (2.53 g). This shows that the reaction yield is close to 100%.

### c. Analysis of the Precipitate

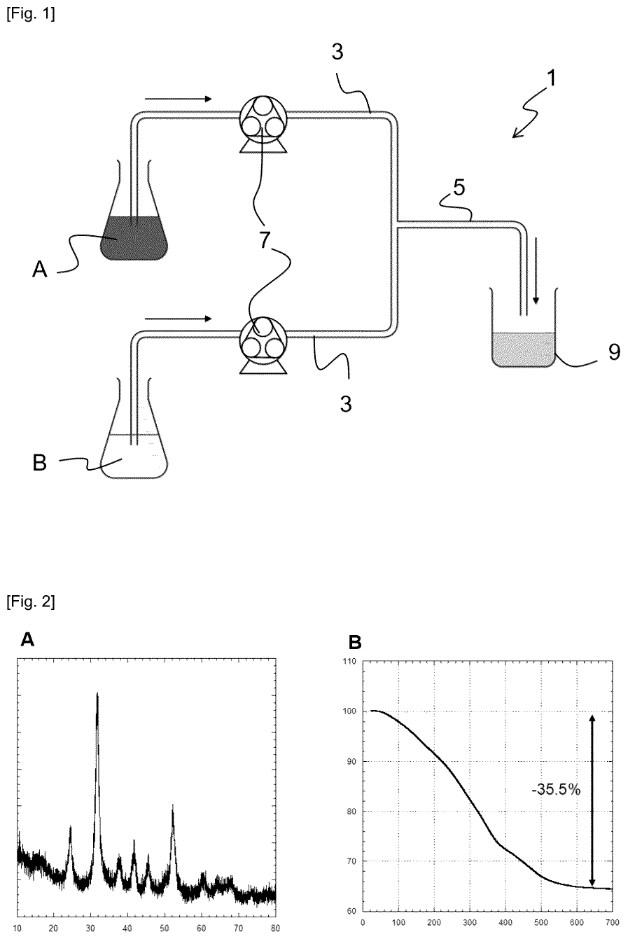

An X-ray diffractogram (XRD) was performed and the result is shown in FIG. 2A. This diffractogram shows that all the lines are indexable in the R-3c space group, the lattice parameters of which are: a=b=4.778(3) Å, c=15.424(9) Å. This diffractogram therefore confirms that a carbonate without any crystallized impurities has been obtained. In addition, a thermogravimetric analysis was performed on around 30 mg of powder in air at a temperature of 25° C. up to 700° C. with an increase rate of 10° C./min. The result is shown in FIG. 2B and also confirms that a carbonate without any crystallized impurities has been obtained as the experimental mass loss (−35.5%) is equivalent to the expected theoretical mass loss (−37.6%).

Chemical analysis was carried out using inductively coupled plasma optical emission spectroscopy (ICP-OES) to determine the chemical composition of the precipitate:

TABLE 3

| | Ni | Mn | Co |
|---|---|---|---|
| Experimental | 0.17 ± 0.01 | 0.53 ± 0.02 | 0.30 ± 0.01 |
| Theory | 0.2 | 0.5 | 0.3 |

The experimental composition is in line with the expected theoretical composition.

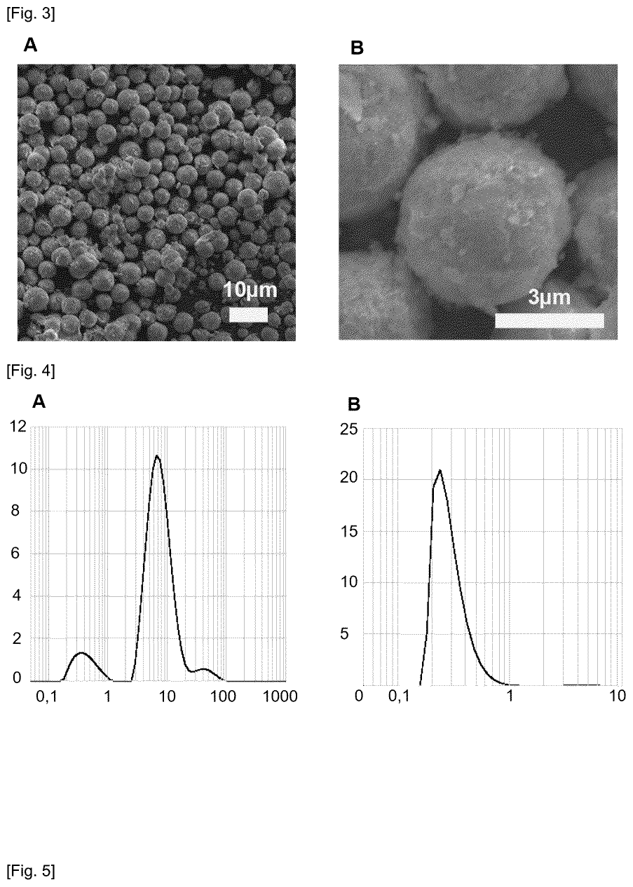

The morphology of the aggregates was verified by scanning electron microscopy (SEM), the results of which are shown in FIG. 3. The observed aggregates have a diameter of around 6 micrometres. This value and the homogeneity were verified by laser granulometry analysis, the results of which are shown in FIG. 4. The volume distribution 50 (D50) of the precipitate is 6.3 μm, in line with the observations carried out using SEM.

### d. Preparing an Active Material and Electrochemical Performance

The inventors then mixed the precursor Ni_{0.2}Mn_{0.5}Co_{0.3}CO₃ with Li₂CO₃ in order to synthesize a positive electrode active material for a battery with the formula:

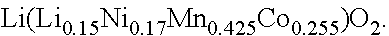

For this, 2 g of Ni_{0.2}Mn_{0.5}Co_{0.3}CO₃ were mixed in an agate mortar with 0.8980 g of Li₂CO₃ (with an excess of 5% by mass in order to prevent any lithium loss during the calcination of the material at high temperature) for at least 5 min until a homogeneous coloured mixture was obtained. The mixture is then positioned in a gold crucible and placed in a tube furnace in order to undergo heat treatment at high temperature in air, the thermal cycle of which is shown in FIG. 5.

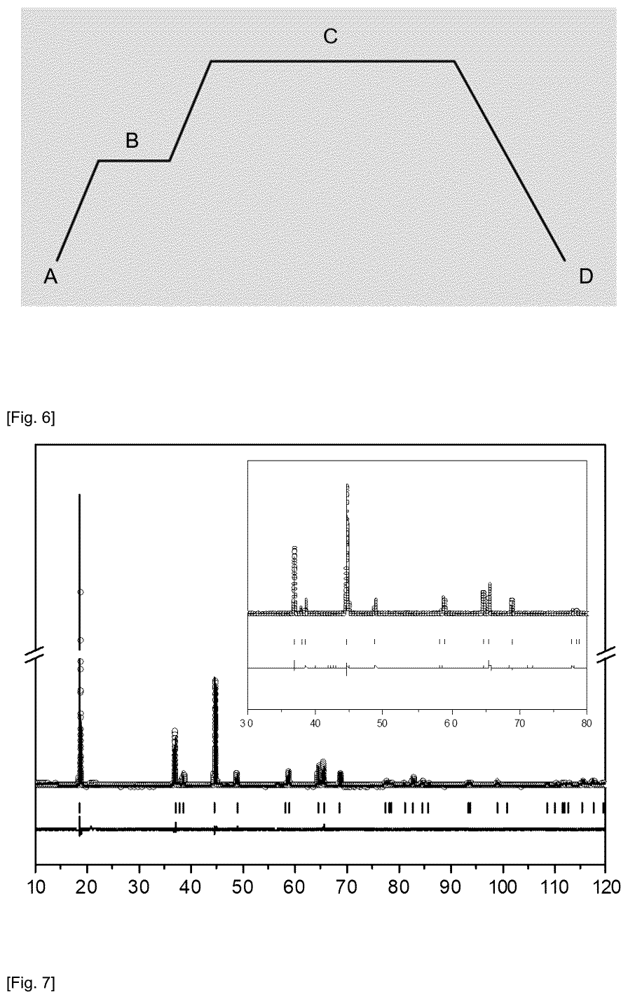

An XRD is performed on the active material. The results are shown in FIG. 6 and confirm that a lamellar oxide has been obtained, the X-ray diffraction pattern of which can be indexed in the space group R-3m with the lattice parameters a=b=2.8470(1) Å et c=14.2171(9) Å. The material obtained after synthesis is pure, no crystallized secondary phase was observed. The lattice parameters obtained after refinement using the Le Bail method are in line with those obtained for this same compound from a precursor synthesized by co-precipitation (a=b=2.8492(3) Å and c=14.219(3) Å). The Le Bail method is described in particular in the document Petricek, V., Dusek, M. & Palatinus, L. (2014). Z. Kristallogr. 229(5), 345-352.

The chemical composition was verified by ICP-OES, the results of which are shown in the following table

TABLE 4

| | Li | Ni | Mn | Co |
|---|---|---|---|---|
| Carbonate | 1.18 ± 0.03 | 0.137 ± 0.004 | 0.435 ± 0.013 | 0.247 ± 0.007 |
| Oxide | 1.15 | 0.144 | 0.450 | 0.255 |
| Theoretical | 1.15 | 0.17 | 0.425 | 0.255 |

The last line of table 2 corresponds to the expected composition for a lithium oxide considering the Ni/Mn/Co ratio of 2/5/3. The carbonate (1st line in the table) and the oxide (2nd line in the table) obtained have a very slight deviation from the expected composition (last line in the table) for a lithium oxide considering the Ni/Mn/Co ratio of 2/5/3. The materials obtained are therefore ideal for use as an active material in a battery cathode.

SEM images shown in FIG. 7 show the morphology of the aggregates of the material obtained. As with the precursor, spherical aggregates of the order of 6 μm were obtained.

An electrode composed of 92% obtained active material, 4% carbon black and 4% polyvinylidene fluoride (92/4/4 in % by mass) was prepared. To do this, a solution of polyvinylidene fluoride dissolved in N-Methyl-2-pyrrolidone (5% by mass) was initially prepared. The active material and carbon black were then suspended in this solution and the required quantity of N-Methyl-2-pyrrolidone was added to obtain a dry matter content of around 30 to 40%. The mixture was left under magnetic stirring for 1 hour. The resulting ink was coated onto an aluminium strip (coating thickness of 150 μm) by the method known as “Doctor Blade” using the Elcometer® 4340 applicator.

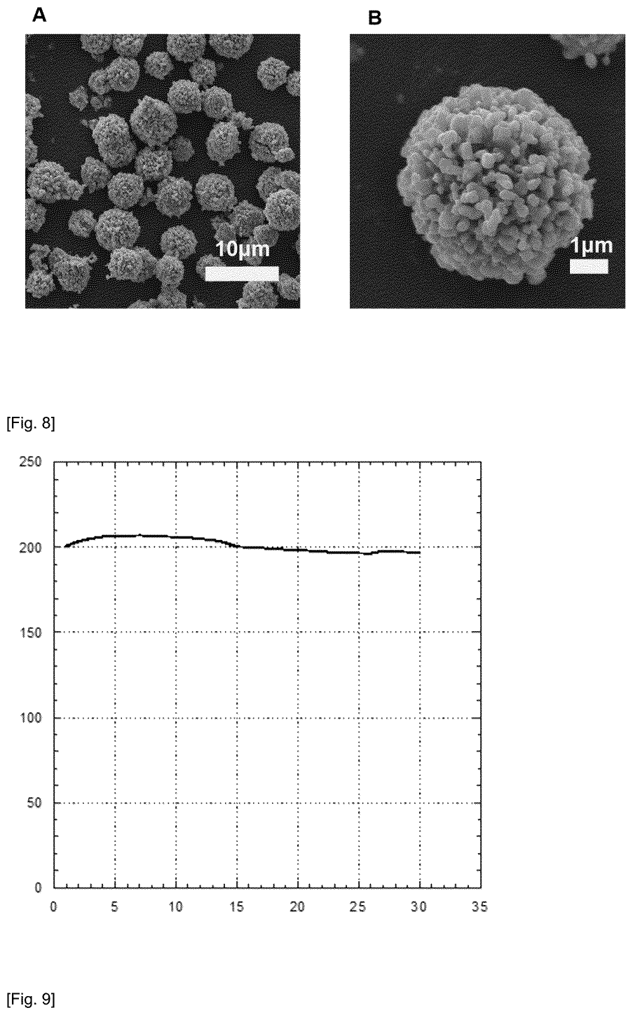

The electrode was finally placed in an oven at 80° C. to evaporate the solvent. Electrodes with a diameter of 16 mm were die-cut and then calendered at a uniaxial pressure of 5 tonnes. Finally, these electrodes were dried at 80° C. in a vacuum for 12 hours before being stored in a glove box under a controlled argon atmosphere. The grammage was 4 mg of active material per cm². Electrochemical tests were then carried out in CR2032 button cells in the presence of Li with 2 Celgard® 2400 separators. The electrolyte used is a mixture of fluoroethylene carbonate (FEC) and dimethyl carbonate (DMC) (30/70 in % by mass) in which 1M lithium hexafluorophosphate (LiPF₆) is dissolved. Successive charge and discharge cycles were carried out at a C/10 regime (i.e. 10 hours to fully charge or discharge the cell). The evolution in discharged capacity as a function of the number of cycles is shown in FIG. 8. This figure shows that the capacity remains stable around 200 mAh/g during the first 30 cycles of cells tested.

### e. Influence of the Residence Time in the Reactor

The inventors tested longer residence times in the discharge tube from the reactor (greater than 10 seconds) and their impact on the morphology and homogeneity of the precursors obtained.

To do this, the initial solutions A and B from example 2.a. were used. Two different reactors were then used (1 and 2), wherein the reactor 1 had a discharge tube length of 1 metre and the reactor 2 had a discharge tube length of 2 metres. Each reactor 1 and 2 had an inner diameter of 1.39 mm. In each case, the sampling flow rate for the solutions A and B was 4 mL/min. The residence time for the discharge tube from the reactor 1 was 11.4 seconds and the residence time in the discharge tube from the reactor 2 was 22.8 seconds. The regime of the fluid in the reactor was laminar. The pH of each solution containing the precipitate was 8.

An X-ray diffractogram (XRD) was performed on the precipitate obtained and the result is shown in FIG. 9. This diffractogram shows that all the lines are indexable in the R-3c space group, the lattice parameters of which are: a=b=4.778(3) Å, c=15.424(9) Å. This diffractogram confirms that a carbonate without any crystallized impurities has been obtained.

The chemical composition was verified by ICP-OES, the results of which are shown in the following table

TABLE 5

| | Ni | Mn | Co |
|---|---|---|---|
| Reactor 1 | 0.18 ± 0.01 | 0.51 ± 0.02 | 0.31 ± 0.01 |
| Reactor 2 | 0.18 ± 0.01 | 0.51 ± 0.02 | 0.31 ± 0.01 |
| Theoretical | 0.2 | 0.5 | 0.3 |

The experimental composition obtained with each reactor is in line with the expected theoretical composition.

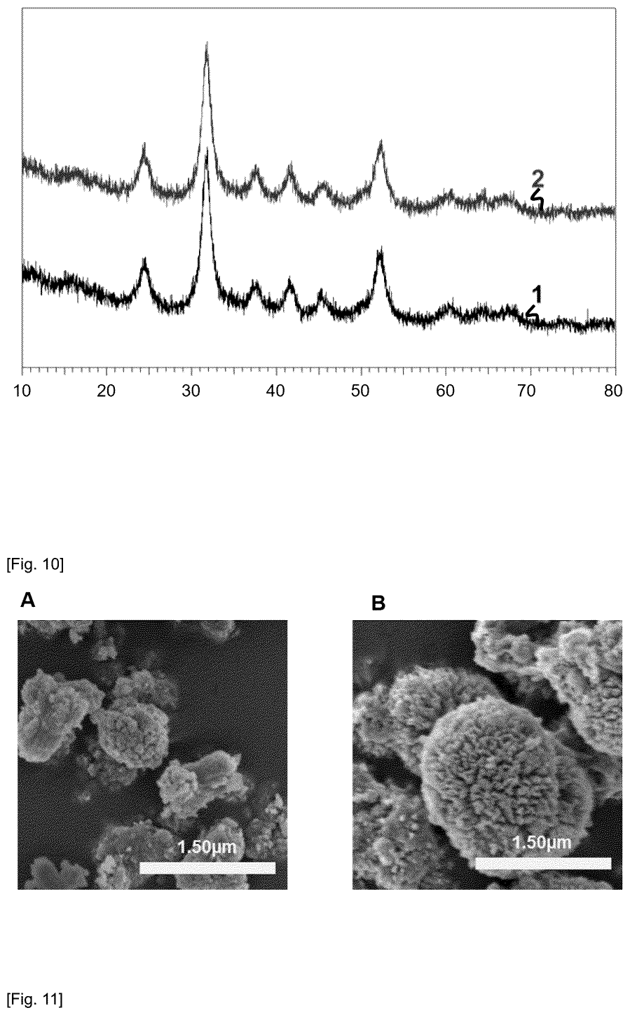

The morphology of the aggregates was verified by scanning electron microscopy, the results of which are shown in FIG. 10. In each case, the aggregates observed were partially spherical with a high degree of heterogeneity in the shape and size of the aggregates. In addition, the size of the aggregates was of the order of 1 μm at best. A residence time of more than 10 seconds in the discharge tube therefore diminishes the properties of the precursor obtained, which no longer has the diameter and homogeneity of the precursors obtained with the synthesis method according to the invention.

### 3. Carbonate Precursor Ni_{0.25}Mn_{0.75}CO₃

The inventors subsequently synthesized a carbonate precursor rich in manganese, the composition of which is Ni_{0.25}Mn_{0.75}CO₃.

### a. Preparing Starting Solutions

To do so, a solution of 50 mL of transition metal sulfates was prepared by weighing 6.57 g of NiSO₄.6H₂O and 12.68 g of MnSO₄·H₂O. These Sulfates were dissolved in distilled water then placed in a volumetric flask of 50 mL filled to the mark. The Ni/Mn/Co molar ratio was ⅓:⅓:⅓. The concentration of this solution is 2 mol/L. A solution of 50 mL containing sodium carbonate and a complexing agent (NH₄OH) was prepared by weighing 10.60 g of Na₂CO₃ and 2.25 g of NH₄OH. Na₂CO₃ was dissolved in distilled water in the presence of NH₄OH then placed in a volumetric flask of 50 mL filled to the mark. The concentration of Na₂CO₃ is 2 mol/L and the concentration of NH₄OH is 0.36 mol/L.

### b. Synthesis Conditions

The solutions were injected into the mixer/reactor system by means of peristaltic pumps. The sampling flow rate for the solution containing the transition metals was set at 5 mL/min (Qa) and the sampling flow rate for the solution containing the carbonate was set at 5 mL/min (Qb) (so Qa=Qb). The reactor was 10 cm long and had an inner diameter of 1.39 mm. Under these conditions, the residence time in the reactor was 0.91 s and the regime of the fluid in the reactor was laminar. In order to ensure the homogeneity of the precipitate that is recovered, the precipitate was not recovered for the first 30 seconds of the reaction, then it was sampled under the aforementioned conditions for 60 seconds. The pH of the solution containing the precipitate was 8.7. The precipitate was then washed by centrifugation with distilled water (until the wash water had been neutralized) and dried in an oven at 70° C. for 1 night.

The mass of transition metal carbonate recovered after drying was 2.33 g, in line with the expected theoretical quantity (2.37 g). This shows that the reaction yield is close to 100%. 2.33 g of carbonates Ni_{0.25}Mn_{0.75}CO₃ were therefore produced in 60 seconds. This constitutes a production of 140 g/h for a 0.15 mL reactor compared with 16 g in a 500 mL batch reactor over 6 h used in the prior art.

### c. Analysis of the Precipitate

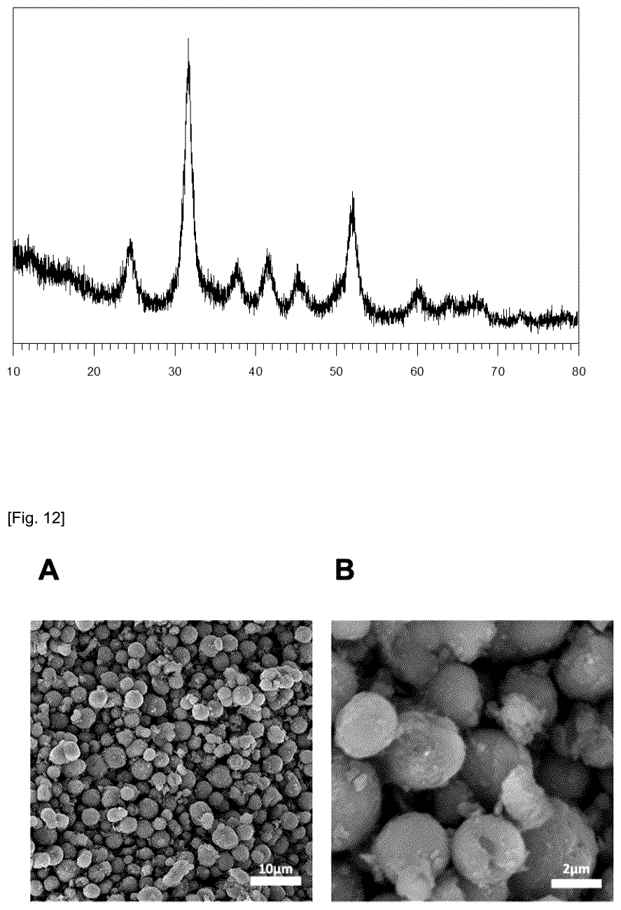

An X-ray diffractogram (XRD) was performed and the result is shown in FIG. 11. This diffractogram confirms that a carbonate without any crystallized impurities has been obtained.

Chemical analysis was carried out using inductively coupled plasma optical emission spectroscopy (ICP-OES) to determine the chemical composition of the precipitate:

TABLE 6

| | Ni | Mn |
|---|---|---|
| Experimental | 0.24 | 0.76 |
| Theory | 0.25 | 0.75 |

The experimental composition is in line with the expected theoretical composition.

The morphology of the aggregates was verified by scanning electron microscopy (SEM), the results of which are shown in FIG. 12. The observed aggregates have a diameter of around 4 micrometres.

All of these characteristics (XRD, ICP-OES, SEM) demonstrate that a transition metal carbonate with controlled composition and morphology has been obtained.

### 4. Carbonate Precursors Ni_{1/3}Mn_{1/3}Co_{1/3}CO₃

The inventors subsequently synthesized a carbonate precursor, the composition of which is Ni_{1/3}Mn_{1/3}Co_{1/3}CO₃.

### A. Preparing Starting Solutions

To do so, a solution of 50 mL of transition metal sulfates was prepared by weighing 8.67 g of NiSO₄·6H₂O, 5.58 g of MnSO₄·H₂O and 9.28 g of CoSO₄·7H₂O. These sulfates were dissolved in distilled water then placed in a volumetric flask of 50 mL filled to the mark. The Ni/Mn/Co molar ratio is ⅓:⅓:⅓. The concentration of this solution is 2 mol/L. A solution of 50 mL containing sodium carbonate and a complexing agent (NH₄OH) was prepared by weighing 10.60 g of Na₂CO₃ and 2.25 g of NH₄OH. Na₂CO₃ was dissolved in distilled water in the presence of NH₄OH then placed in a volumetric flask of 50 mL filled to the mark. The concentration of Na₂CO₃ is 2 mol/L and the concentration of NH₄OH is 0.36 mol/L.

### b. Synthesis Conditions

The solutions were injected into the mixer/reactor system by means of peristaltic pumps. The sampling flow rate for the solution containing the transition metals was set at 15 mL/min (Qa) and the sampling flow rate for the solution containing the carbonate was set at 15 mL/min (Qb) (so Qa=Qb). The reactor was 10 cm long and had an inner diameter of 1.39 mm. Under these conditions, the residence time in the reactor was 0.3 s and the regime of the fluid in the reactor was laminar. In order to ensure the homogeneity of the precipitate that is recovered, the precipitate was not recovered for the first 30 seconds of the reaction, then it was sampled under the aforementioned conditions for 60 seconds. The pH of the solution containing the precipitate was 7.3. The precipitate was then washed by centrifugation with distilled water (until the wash water had been neutralized) and dried in an oven at 70° C. for 1 night.

The mass of transition metal carbonate recovered after drying was 2.24 g, in line with the expected theoretical quantity (2.27 g). This shows that the reaction yield is close to 100%. 2.24 g of carbonates Ni_{1/3}Mn_{1/3}Co_{1/3}CO₃ were therefore produced in 60 seconds. This constitutes a production of 136 g/h for a 0.15 mL reactor compared with 16 g in a 500 mL batch reactor over 6 h used in the prior art.

### c. Analysis of the Precipitate

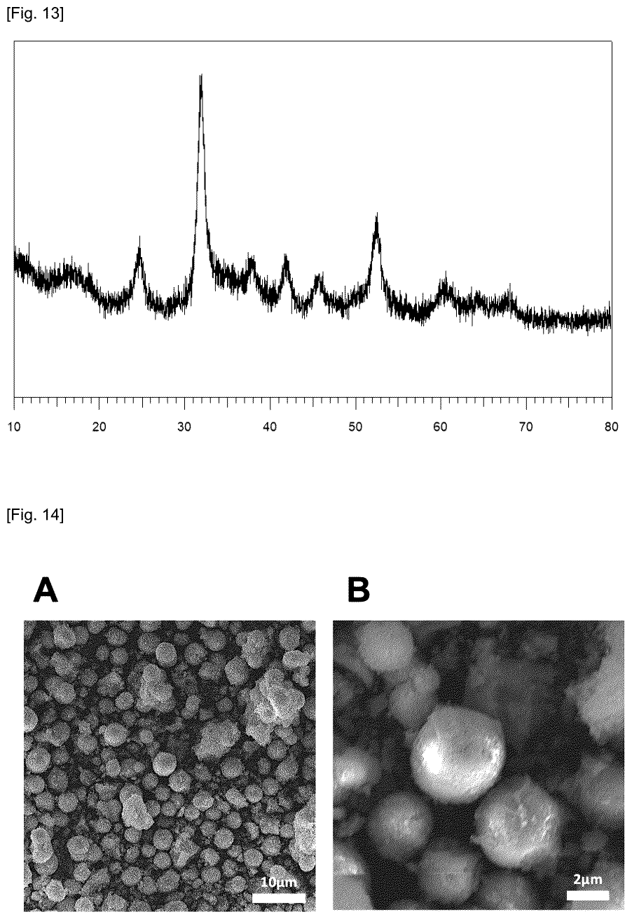

An X-ray diffractogram (XRD) was performed and the result is shown in FIG. 13. This diffractogram indicates that a carbonate with a slight presence of oxyhydroxide has been obtained.

Chemical analysis was carried out using inductively coupled plasma optical emission spectroscopy (ICP-OES) to determine the chemical composition of the precipitate:

TABLE 7

| | Ni | Mn | Co |
|---|---|---|---|
| Experimental | 0.33 | 0.33 | 0.33 |
| Theory | 0.33 | 0.33 | 0.33 |

The experimental composition is in line with the expected theoretical composition.

The morphology of the aggregates was verified by scanning electron microscopy (SEM), the results of which are shown in FIG. 14. The observed aggregates have a diameter of around 5 micrometres.

All of these characteristics (XRD, ICP-OES, SEM) demonstrate that a transition metal carbonate with controlled composition and morphology has been obtained.

### d. Influence of the Regime in the Reaction Tube

The inventors tested the influence of the regime in the reaction tube with regard to obtaining the precursor Ni_{1/3}Mn_{1/3}Co_{1/3}CO₃.

To do this, a 50 mL solution of metal sulfates was prepared with an Ni/Mn/Co molar ratio of ⅓:⅓:⅓, and a concentration of 0.1 mol/L. A 50 mL solution containing 0.2 mol/L ammonium bicarbonate was also prepared.

The solutions were injected into the mixer/reactor system by means of peristaltic pumps. The sampling flow rate for the solution containing the transition metals was set at 50 mL/min (Qa) and the sampling flow rate for the solution containing the carbonate was set at 50 mL/min (Qb) (so Qa=Qb). The reactor was 10 cm long and had an inner diameter of 1.39 mm. Under these conditions, the regime of the fluid in the reactor was laminar. In order to ensure the homogeneity of the precipitate that is recovered, the precipitate was not recovered for the first 30 seconds of the reaction, then it was sampled under the aforementioned conditions for 60 seconds. The pH of the solution containing the precipitate was 7.5. The precipitate was then washed by centrifugation with distilled water (until the wash water had been neutralized) and dried in an oven at 70° C. for 1 night.

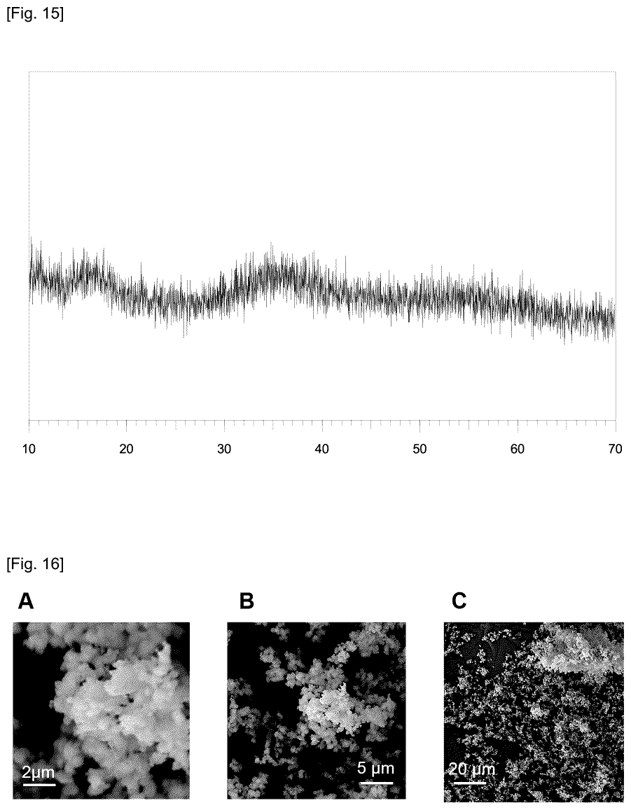

An X-ray diffractogram (XRD) was performed and the result is shown in FIG. 15. This diffractogram shows that no crystallized phase has precipitated, and it has therefore not been possible to obtain a carbonate with an Ni_{1/3}Mn_{1/3}Co_{1/3}CO₃ composition using this method.

The morphology of the aggregates was verified by scanning electron microscopy (SEM), the results of which are shown in FIG. 16. This figure clearly shows that no sphericity has been obtained, and demonstrates that an intermediate regime does not produce a carbonate with an Ni_{1/3}Mn_{1/3}Co_{1/3}CO₃ composition.

What is claimed is:

1. Method for synthesising spherical material particles, said method being carried out in a continuous reactor, said continuous reactor being formed by a reaction tube, said reaction tube being supplied by two intake tubes, the reaction tube having a length L,
one of the two intake tubes being supplied with a solution A comprising at least one transition metal sulfate chosen from among nickel (Ni), aluminium (Al), magnesium (Mg), titanium (Ti), copper (Cu), zinc (Zn), iron (Fe), manganese (Mn) and cobalt (Co),
the other intake tube being supplied with a solution B comprising a hydroxide or a carbonate and optionally a chelating agent,
said method comprising the following steps:
a) delivering solutions A and B to the reaction tube of the continuous reactor at a flow rate of d_{A} and d_{B} respectively, resulting in the precipitation of a precursor in the reaction tube, and
b) recovering said precipitated precursor at the outlet of the reaction tube,
wherein the length L of the reaction tube and the delivery flow rates d_{A} and d_{B} are configured such that the residence time in the reaction tube is less than or equal to 10 seconds, wherein the pH in the reaction tube is 7 to 12 and wherein the regime in the reaction tube is a laminar regime.

2. Synthesis method according to claim 1, wherein the residence time in the reaction tube is between 1 millisecond and 10 seconds, the residence time in the reaction tube is preferably less than or equal to 5 seconds, the residence time in the reaction tube is more preferably still less than or equal to 1 second.

3. Synthesis method according to claim 1, wherein the length L of the reaction tube is at least 1 mm.

4. Synthesis method according to claim 1, wherein the inner diameter of each intake tube and the reaction tube is at least 0.5 mm, the inner diameter of each intake tube is preferably greater than 1 mm, the inner diameter of each intake tube and the reaction tube is more preferably still between 1 and 1.5 mm.

5. Synthesis method according to claim 1, wherein the temperature in the reaction tube is between 20° C. and 70° C., preferably between 25° C. and 50° C.

6. Synthesis method according to claim 1, wherein the solution A comprises at least three transition metal sulfates chosen from among nickel (Ni), aluminium (Al), manganese (Mn) and cobalt (Co).

7. Synthesis method according to claim 1, wherein the hydroxide is chosen from the group made up of sodium hydroxide, potassium hydroxide, 8-hydroxyquinoline, ammonia, lithium hydroxide and mixtures thereof, the hydroxide is preferably sodium hydroxide.

8. Synthesis method according to claim 1, wherein the carbonate is chosen from the group made up of ammonium bicarbonate, sodium carbonate, potassium carbonate, lithium carbonate and mixtures thereof, the carbonate is preferably sodium carbonate.

9. Synthesis method according to claim 1, wherein each solution A and B is delivered by means of a peristaltic pump.

10. Synthesis method according to claim 1, wherein the delivery flow rates d_{A} and d_{B} are each at least 0.01 m/min.
